(19) United States
(12) Patent Application Publication
(10) Pub. No.: US 2020/0316685 A1
(43) Pub. Date: Oct. 8, 2020

(54) INSITU METAL MATRIX NANOCOMPOSITE SYNTHESIS BY ADDITIVE MANUFACTURING ROUTE

(71) Applicant: Oerlikon Surface Solutions AG, Pfäffikon, Pfäffikon (CH)

(72) Inventor: Siva Phani Kumar YALAMANCHILI, Sargans (CH)

(21) Appl. No.: 16/485,609

(22) PCT Filed: Feb. 9, 2018
(86) PCT No.: PCT/EP2018/000053

§ 371 Date: Aug. 13, 2019

(30) Foreign Application Priority Data
Feb. 13, 2017 (EP) 17000219.0

(51) Int. Cl. B22F 3/105; B33Y 30/00; B33Y 80/00; B33Y 70/00; B33Y 10/00

(52) U.S. Cl. CPC B22F 3/105; B33Y 30/00; B33Y 80/00; B22F 2301/052; B33Y 10/00; B22F 2003/1056; B22F 2301/205; B33Y 70/00

(57) ABSTRACT

A unique and novel additive manufacturing route has been proposed to form a thermally stable in-situ metal matrix nano composite by interfacing reactive plasma in the selective laser melting process chamber. The proposed route gives very high compositional freedom, i.e, nitrides, carbides, oxides, suicides and other ceramics with different stoichiometries can be reinforced in nanoscale in any metallic matrix. Components with such a nanocomposite structure dispiay superior high temperature structural properties.

The present invention relates to a method to form insitu metal matrix nanocomposites by additive manufacturing, Examples are carbides, nitrides, oxides, borides or a combination of them in a metal matrix of feed stock material,

Prior Art:

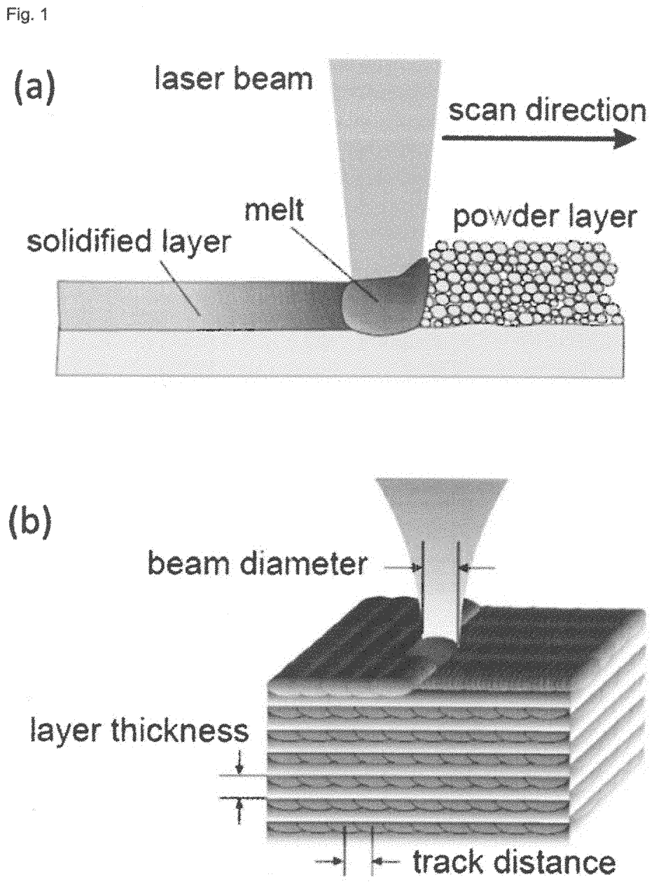

Selective laser melting (SLM) is the work horse for additive manufacturing of metallic components. The process is thoroughly investigated and published in research articles like C. Y. Yap et al., Review of selective laser melting: Materials and applications, Appl, Phys. Rev. 2, 041101(2015) 041101. The state of the art process is schematically shown in FIG. 1, in brief, the process consists of spreading the powder (preferably atomized powder) followed by laser rastering to cause selective melting (FIG. 1a). Powder spreading and laser rostering is re iterated until the desired shape is achieved (FIG. 1b). Though the state of the art was claimed to mass produce metallurgically sound intricate geometrical designs in industrial scale, it suffers from limited compositional and micro-structural freedom, i.e., the phase constituents of the printed components are essentially defined by the feed stock material, The final micro-structure is often an equilibrium and metastable phase mixture of the constituents from the feed stock.

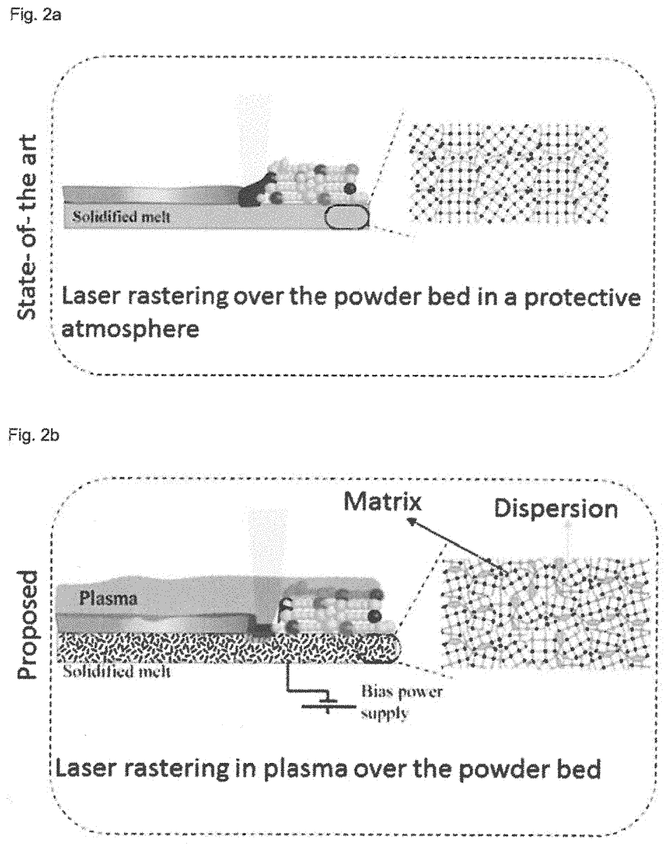

In contrast to the state of the art, in the proposed method according to the present invention an insitu nanoscale precipitate structure is formed in the metallic matrix of the feed stock in a uniquely designed process configuration as for example shown in FIG. 2,

The proposed process comprises the steps of laser rastering on the powder bed in a reactive plasma environment, coupled with applying an electro static potential (bias) to the build plat form. By appropriately interfacing the laser rasteting, reactive plasma and the bias voltage, a nanocomposite is formed insitu, in the metal matrix as schematically shown in FIG. 2. The proposed method has a very high compositional freedom, nano particles of nitrides, oxides, carbides, and silicides of various stoichiometry can be incorporated in almost any metal matrix. More interestingly, such a nanocomposite is thermally stable as the particle growth by the Ostwald ripening process is experimentally negligible due to relatively a low mutual solid solubility between the particles and matrix.

It is known from the current literature that a homogeneous distribution of nanoparticles of nitrides, carbides, borides or oxides in a metal matrix will significantly enhance the high temperature structural properties by hindering the plastic flow, even with a volume fraction as low as 5%, see for example:
(a) G J. Zhang et al., Microstructure and strengthening mechanism of Oxide lathanum dispersion strengthened molybdenum ahoy, Adv. Eng. Mater. 2004, 6, No. 12,
(b) http://www.ifam.fraunhofer.de/content/dam/ifam/en/documents/dd/Infobi%C3%A4tter/dispersion-strengthened materials fraunhofer ifam dresden.pdf)

In summary, 3D printed components in the proposed configuration are characterized with a thermally stable non-equilibrium mixture of nanoscale ceramic particles homogeneously distributed in the feedstock matrix. Such nanoscale particle reinforced 3D printed components display significantly superior structural properties at room and elevated temperature of 0.7 Tm (Tm is the melting temperature of the matrix alloy)

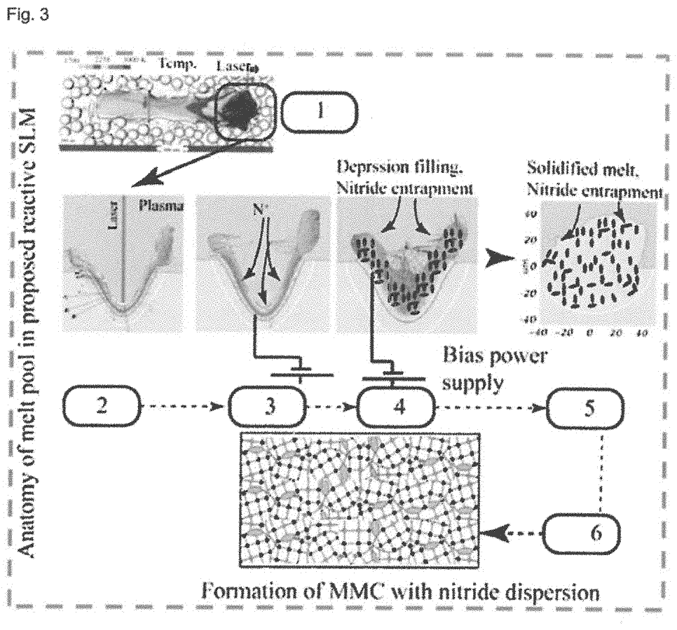

The goal is to provide for an additive manufacturing synthesis route to form metalmatrix nanocomposite it situ almost with any metallic feed stock. The schematic of the proposed synthesis route is enclosed in FIG. 3.

The method according to the present invention comprises 6 steps:

Step 1: Reactive plasma is ignited in the chamber preferentially on the powder bed, preferably a ME powder bed where the Me powder is a metal comprising powder and simultaneously an electrostatic potential of several 100 eV is applied in the melt zone via the build plat form.

Step 2: Laser rastering on the powder bed causes molten pool formation very locally.

Step 3: Reactive gas ions (N+) are electrostatically driven in to the molten pool with an energy of several 100 eV.

Step 4: The chemical interaction between the molten feed stock and reactive gas ions causes ceramic compounds such as carbides, nitrides, oxides, silicides formation insitu for example by the following reaction path way: {Me(I)+X+(g)→MeN (s)}.

Step 5 (optional step, however preferably): By tuning the laser power, rastering speed, bias voltage; plasma reactivity, hydrodynamic forces and fluid recirculation pattern of the molten feedstock is influenced to cause nitride precipitates break down preferentially to nanoscale before the liquid pool solidifies.

Step Formation of metal matrix composite with nanoscale dispersion after solidification,

Please note that in the steps as described above N+ can be replaced by any reactive gas such as for example (O+, Si+, B+, C+) or mixtures thereof, in step 4 I, g, and s are numbers reflecting the atomic percentage. Me could be, for example Ti andior Al and/or a mixture thereof.

Though the process is illustrated for SLM process, experts in the field will agree that this can be applied in other melting based additive manufacturing route.

FIG. 1: Schematic illustration of (a) layer spreading and laser melting, (b) forming desired shape by selective laser melting process

FIG. 2: Structural differences of the additive manufactured co with tide a) state of the art and b) the proposed synthesis route

FIG. 3: Pictorial representation of insitu metal matrix nanocomposite formation in the proposed synthesis route. Numbers in the picture represents sequential process steps explained in the text.

1. Additive, manufacturing synthesis method to form a component comprising a metal matrix nanocomposite, the method comprising the steps of:
Reactive plasma ignition in the chamber preferentially on a Me powder bed, where the Me powder is a metal comprising powder and simultaneously applying an electrostatic potential of several 100 eV in the melt zone via the build platform
Laser raste ing on the powder bed to cause molten pool formation very locally
Electrostatically driving reactive gas ions X+ as for example (N+, O+, Si+, B+, and/or C+) into the molten pool with an energy of several 100 eV.
Causing chemical interaction between the molten feed stock and reactive gas ions to form ceramic compounds such as carbides, nitrides, oxides, and/or silicides insitu for example: by the following reaction path way: {Me(I)+X+(g)→MeX(s)},
Solidifying and thereby forming the metal matrix composite with nanoscale dispersion,

2. Method according to claim 1, characterized in that the laser power and or rastering speed and/or bias voltage is tuned to influence plasma reactivity and/or hydrodynamic forces and/or fluid recirculation pattern of the molten feedstock to cause nitride precipitates break down preferentially to nanoscale before the liquid pool solidifies.

3. Method according to one of the claims 1 and 2, characterized in thatreactive gas ions X+ are N+ ions.

4. Method accordingne of the claims 1 to 3, characterized that Me is Ti and/dr Al or a mixture thereof.
